(19) United States
(12) Patent Application Publication
(10) Pub. No.: US 2025/0116997 A1
(43) Pub. Date: Apr. 10, 2025

(54) PRODUCT IDENTIFICATION AND TRACKING SYSTEMS AND METHODS

(71) Applicant: Raytheon Company, Tewksbury, MA (US)

(72) Inventors: Brian F. Campinell, Lynnfield, MA (US); Paulo Meireles Cavalcanti, Dracut, MA (US); Robert Di Carlo, Boxford, MA (US)

(73) Assignee: Raytheon Company, Waltham, MA (US)

(21) Appl. No.: 18/378,078

(22) Filed: Oct. 9, 2023

(51) Int. Cl. G05B 19/418

(52) U.S. Cl. CPC G05B 19/41865; G05B 2219/42337

(57) ABSTRACT

In accordance with at least one aspect of this disclosure, a product identification and tracking interface system includes an interface unit. The interface unit includes an input/output configured and adapted to be coupled to at least one of a tracking system or an identification system, a memory configured to store instructions, and a processor disposed in communication with said memory. The processor upon execution of the instructions is configured to receive a trigger command from a tracking system, send a read command to an identification system, receive a respective identifier from the identification system, package the respective identifier into a packaged identifier in a format readable by the tracking system, and send the packaged identifier to the tracking system.

### FIELD

This disclosure relates to product identification and tracking and integration systems and methods therefor.

### BACKGROUND

In the quest for ‘access to’ and ‘utilization of’ manufacturing data, the ability to capture, tag and align collected manufacturing data to the associated physical product is desired to drive operational efficiencies within the factory. Traditional alignment of manufacturing data (i.e. Machine, Product, and Sensor Data) to the serialized product information for products assembled using the surface mount technology (SMT) process is sometimes inhibited by the various product assembly configurations and inherent machine product recognition capabilities.

There are many approaches available in the manufacturing industry to accomplish product recognition/identification. Many of these approaches require some modification to the physical product, e.g., barcodes, RFID tags, and the products technical data package. This may present barriers to efficiency in a high-mix, low-volume environment, e.g., where many different assemblies or configurations of a product are made in small batches on the same production line, as the lack of a standard set of assembly configurations coupled with variability of machine product recognition capability presents challenges for the collection and alignment of data.

In order to take full advantage of the capabilities of certain tracking applications and tools, the collected data must be aligned with the product identification data in order to enhance the output data resolution, as well as, enable ‘real time’ product flow control of the manufacturing process. Traditional identification approaches may limit the utilization of advanced features in certain tracking software since they are restricted from a ‘universal’ application.

Such conventional methods and systems have generally been considered satisfactory for their intended purpose. However, there is still a need in the art for improvements. The present disclosure provides a solution for this need.

### SUMMARY

In accordance with at least one aspect of this disclosure, a product identification and tracking interface system includes an interface unit. The interface unit includes an input/output configured and adapted to be coupled to at least one of a tracking system or an identification system, a memory configured to store instructions, and a processor disposed in communication with said memory. The processor upon execution of the instructions is configured to receive a trigger command from a tracking system, send a read command to an identification system, receive a respective identifier from the identification system, package the respective identifier into a packaged identifier in a format readable by the tracking system, and send the packaged identifier to the tracking system.

One or more embodiments include the system/apparatus of any previous paragraph, and wherein the read command can prompt the identification system to capture a product image.

One or more embodiments include the system/apparatus of any previous paragraph, and wherein the respective identifier can be based on the product image.

One or more embodiments include the system/apparatus of any previous paragraph, and wherein the respective identifier can be an alpha-numeric identifier in the form of a meta-data message packet.

One or more embodiments include the system/apparatus of any previous paragraph, and wherein the respective identifier can include a stored identifier within the identification system.

In accordance with another aspect, a product identification and tracking system includes an identification system, a tracking system, and an interface unit coupled between the identification system and the tracking system. The interface unit includes an input/output configured and adapted to be coupled to at least one of the tracking system or the identification system, a memory configured to store instructions, and a processor disposed in communication with said memory. The processor upon execution of the instructions is configured to receive a trigger command from the tracking system, send a read command to the identification system, receive a respective identifier from the identification system, package the respective identifier into a packaged identifier in a format readable by the tracking system, and send the packaged identifier to the tracking system.

One or more embodiments include the system/apparatus of any previous paragraph, and wherein the identification system can be a distributed identification system, having at least a portion of the identification system stored in the interface unit.

One or more embodiments include the system/apparatus of any previous paragraph, and wherein the read command can prompt the identification system to capture a product image.

One or more embodiments include the system/apparatus of any previous paragraph, and wherein the respective identifier is based on the product image.

One or more embodiments include the system/apparatus of any previous paragraph, and wherein the respective identifier can be an alpha-numeric identifier in the form of a meta-data message packet.

One or more embodiments include the system/apparatus of any previous paragraph, and wherein the respective identifier can be a stored identifier within the identification system.

In accordance with another aspect, a method for interfacing between an identification system and tracking system includes receiving a trigger command from a tracking system in an interface system. The method includes sending a read command to at least one identification system, receiving a respective identifier in the interface system from the identification system, packaging the respective identifier into a packaged identifier in a format readable by the tracking system, and sending the packaged identifier to the tracking system.

One or more embodiments include the method of any previous paragraph, and wherein the method can include capturing an image of a product with the identification system.

One or more embodiments include the method of any previous paragraph, and wherein the method can include retrieving the respective identifier from a storage with the identification system based on the image.

These and other features of the embodiments of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a schematic diagram of an embodiment of a system in accordance with this disclosure; and

FIG. 2 is a schematic diagram of an embodiment of a method in accordance with this disclosure.

### DETAILED DESCRIPTION

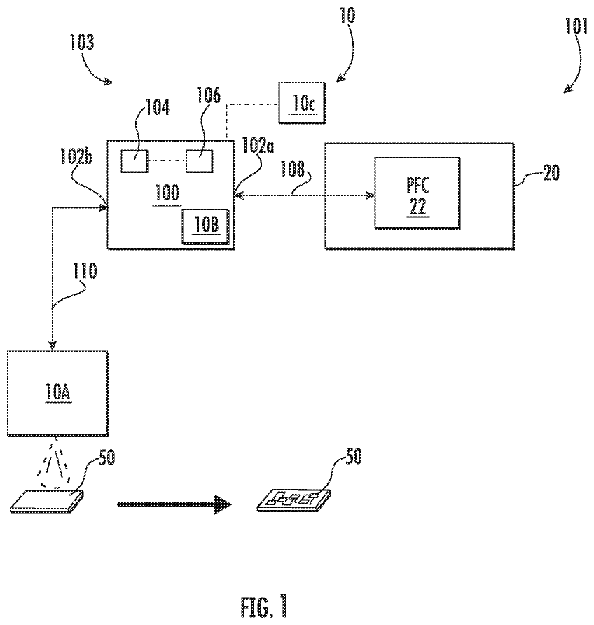

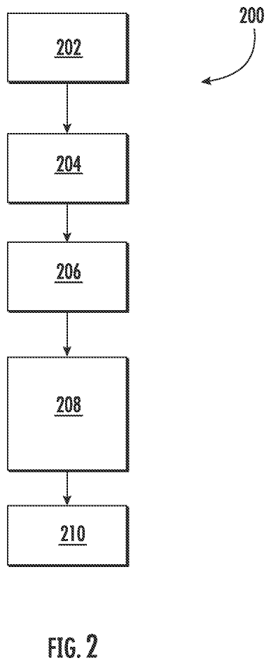

Reference will now be made to the drawings wherein like reference numerals identify similar structural features or aspects of the subject disclosure. For purposes of explanation and illustration, and not limitation, an illustrative view of an embodiment of an interface unit of a product identification and tracking interface system in accordance with the disclosure is shown in FIG. 1 and is designated generally by reference character 100. Other embodiments of systems or methods in accordance with the disclosure, or aspects thereof, are provided in FIG. 2, as will be described.

The systems and methods described herein provide systems and methods for a standardized ‘universal’ product identification approach, to capture, tag, and align manufacturing process data. This identification will enable a more robust data analytic applications and use of factory intelligence software tools. Embodiments of the present disclosure provide systems and methods for interfacing separate identification and tracking technology solutions to work seamlessly as an overall product assembly integrated solution that can be used across a low-volume, high-mix manufacturing environment, where a variety of product configurations are manufactured on a single product line.

In accordance with one embodiment of the present disclosure, as shown in FIG. 1, a product identification and tracking system 101 includes an identification system 10, a tracking system 20, and an interface unit 100. In some embodiments, interface unit 100 is operatively coupled between the identification system 10 via a communication line 110 and tracking system 20 via a communication line 108. Interface unit 100 includes a first input/output 102a configured and adapted to be operatively coupled to tracking system 20 via the communication line 108. Tracking system 20 includes a product flow controller (PFC) 22 which is in communication with interface unit 100 via communication line 108. In accordance with some embodiments, tracking system 20 can be centralized (e.g., one instance), while it can include a plurality of PFCs 22 each connected to a respective one of a plurality of interface units 100, which in turn are each connected to a respective one of a plurality of identification systems 10 and/or a plurality of portions thereof (e.g., a plurality of interface units 100 each connected to a respective one of a plurality of image stations 10A), depending on the number of instantiations within the assembly line. Interface unit 100 includes a second input/output 102b configured and adapted to be operatively coupled to its associated identification system 10, e.g., imaging station 10A, via communication line 110.

As shown in FIG. 1, interface unit 100 includes a memory 104 configured to store instructions and a processor 106 disposed in communication with said memory 104. In accordance with some embodiments, interface unit 100 is an edge IIoT engine to emulate a bar code scanning device using a trigger from PFC 22 of tracking system 20 to activate image station 10A of identification system 10, receive a respective identifier from the identification system 10, package the respective identifier into a packaged identifier in a format readable by tracking system 20, e.g., as a barcode scan read data packet. Those skilled in the art will readily appreciate in view of this disclosure that, in this embodiment, the two technologies (identification system 10 and tracking system 20) are completely transparent to each other, but operate as a seamlessly integrated process, making retrofit or modification of existing product assembly lines readily available.

With continued reference to FIG. 1, in accordance with an embodiment of the present disclosure, interface unit 100 merges together two independent commercially available technologies that operate in adjacent technology solution domains-a tracking system 20 (which includes a Product Flow Controller (PFC 22), and a distributed identification system 10 (which at least includes components 10A, 10B and 10C), to form a complete ‘integrated’ solution for ‘physical’ product identification tied to data supporting ‘intelligent’ software at the machine and factory level.

In accordance with some embodiments, interface system 100 can include or be incorporated with Ignition® technology, developed and available from Inductive Automation Co., located in Folsom, California, which provides an end-to-end Industrial Internet of Things (IIoT) solutions platform. The technology provides the capability to connect hardware and software components from edge devices to data management systems throughout the enterprise. In accordance with embodiments of the present disclosure, each interface system 100 includes an edge IIoT interface engine positioned at a given stage in a manufacturing environment.

In accordance with some embodiments, identification system 10 can include or be incorporated with FeaturePrint® technology, developed and available from Alitheon Co., located in Bellevue, Washington, which provides identification and traceability of individual components by detecting the minute physical surface details that make a product unique. The technology transforms physical products (or an image of a product) into unique digital fingerprints. In accordance with embodiments of the present disclosure, each identification system 10 includes an image station 10A positioned at a given stage in a manufacturing environment and would include a light source and a camera to capture an image of a given product 50 as it passes through the manufacturing environment at a given stage, but would not require any modification to the physical product or its technical data package to identify products. Inclusion of identification systems 10 is transparent to the manufacturing environment and therefore would have no impact to machine environment, the manufacturing processes, or the manufacturing environment.

With continued reference to FIG. 1, in accordance with an embodiment of the present disclosure, interface unit 100 integrates FeaturePrint® product recognition technology with tracking system 20. In some embodiments, tracking system 20 is a “Factory Intelligence” software/system, developed by Cogiscan, of Quebec, Canada, which provides a suite of tools to efficiently monitor line and machine performance across the factory and includes analytics. In one embodiment, this “Factory Intelligence” system 20 includes a hardware component called a PFC, used to control the flow of product within the manufacturing assembly environment. The PFC within the “Factory Intelligence” system 20 uses a prescribed product recognition ‘interface’, which is aligned to a target chosen product recognition technique called Barcoding. The integrated solution will enable the alignment of a physical product to corresponding data collected during the manufacturing of the product. This interfacing will enable tracking system 20, e.g., part of the “Factory Intelligence” system, to have greater data resolution and provide a pathway for complete “real time” product “process” flow control within the assembly line.

In traditional applications, a PFC is used for product flow control on the assembly line, and operates in a SMEMA (Surface Mount Equipment Manufacturers Association) ‘interlock’ capacity to hold off product and enable a barcode scanner to perform product recognition and validation at various points in manufacturing. In accordance with systems and methods of the present disclosure, as shown in FIG. 1, no barcode scanner is needed. Instead, interface unit 100 enables PFC 22 of tracking system 20 to trigger the Alitheon ‘Featureprint’ Technology for product identification, authentication. Interface unit 100 acts as an auto trigger communication interface in between these two adjacent technology products (tracking system 20 and identification system 10), to trigger the identification system 10 (e.g., Alitheon “Featureprint”), for product authentication and return results (in an appropriate format) to the PFC of tracking system 20.

With continued reference to FIG. 1, in accordance with an embodiment of the present disclosure, interface unit 100 is configured to receive a trigger command from the tracking system 20, e.g., via a communication line. Interface unit 100 is configured to send a read command to an authentication portion 10B of identification system 10. The authentication portion 10B of identification system 10 then sends a capture command to its associated image station 10A of identification system 10, e.g., via the communication line 110. The capture command prompts identification system 10 to capture a product image, e.g., of product 50, schematically shown in FIG. 1.

An authentication portion 10B of identification system 10 then generates a unique digital fingerprint from the product image and sends it to a correlation portion 10C of identification system 10 and algorithmically correlates the image to a stored unique digital fingerprint. Each stored unique digital fingerprint correlates to a respective unique product identifier. The stored unique digital fingerprint is generated and stored during a registration process along with a respective unique product identifier in the form of a ‘meta data’ message packet within an correlation portion 10C of identification system 10. Based on this correlation, identification system 10 then returns the ‘meta-data’ identification of given product 50, by way of authentication portion 10B, to processor 106 (e.g., Ignition® edge IIoT interface engine). Processor 106 upon execution of the instructions is configured to receive the respective identifier in the interface system from identification system 10, and package the respective identifier into a packaged identifier in a format readable by tracking system 20.

With continued reference to FIG. 1, in accordance with an embodiment of the present disclosure, each respective identifier is a stored identifier from correlation portion 10C within identification system 10 (which stores the unique identifiers in a correlated manner with their respective previously registered unique digital fingerprints). In this way, as a given product 50 moves through stages of production, the identifier initially assigned to a given product based on its unique digital fingerprint is consistently assigned to its respective product 50 throughout production. Those skilled in the art will readily appreciate that the respective identifier is an alpha-numeric identifier in the form of a meta-data message packet. Each identifier is packaged by interface unit 100 as a meta-data message data packet aligned to the format required by the tracking system 20, e.g., packaged as a barcode ‘read data packet’ message readable by the PFC of tracking system 20. This is particularly advantageous as many existing PFCs are configured and adapted to already read barcode labeled products. By packaging the identifier to mimic a format already readable by the existing systems, interface unit 100 can readily be retrofit into existing product assembly workflows.

With reference now to FIG. 2, in accordance with an embodiment of the present disclosure, a method 200 for interfacing between an identification system, e.g., identification system 10, and tracking system, e.g., tracking system 20, includes receiving a trigger command from a tracking system in an interface unit, e.g. interface unit 100, of an interface system 103, shown schematically by box 202. Method 200 includes sending a read command to at least one identification system, shown schematically by box 204. This read command acts to prompt an image station, e.g., image station 10A, of the identification system to generate an image, e.g., by way of a camera. Identification system 10 assigns a digital fingerprint to the image which is then matched to a respective identifier. Method 200 includes receiving the respective identifier from the identification system 10 in the interface unit, shown schematically by box 206. Method 200 includes packaging the respective identifier into a packaged identifier in a format readable by the tracking system, shown schematically by box 208. Method 200 includes sending the packaged identifier to the tracking system, shown schematically by box 210. From there, the tracking system can use the identifier and correlate it with manufacturing data as it normally would a barcode. If the identification system 10 is unable to match a respective identifier to the fingerprint of a given product, identification system 10 will return a ‘no match’ message, with no ‘meta-data’ identification.

Embodiments of the present disclosure allow for an identification and tracking system without the traditional limitations (e.g., physical modification of products with tags or barcodes) of certain factory intelligence systems. Embodiments of the present disclosure allow for an “identification” or “inspection” software to be transformed into a broadly applicable digital manufacturing tracking system. Overall, embodiments of the present disclosure provide for an interface system 103 having an interface unit 100 that allows for ‘real time’ process control in a low-volume high-mix manufacturing environment, which can be very difficult to achieve in traditional systems because of the physical hurdles involved with implementing a complete standardization of product recognition technology across the product manufacturing spectrum (e.g., placing physical tags on all products, which are also readable by the same barcode scanners in the same positions).

Embodiments can include any suitable computer hardware and/or software module(s) to perform any suitable function (e.g., as disclosed herein). As will be appreciated by those skilled in the art, aspects of the present disclosure may be embodied as a system, method or computer program product. Accordingly, aspects of this disclosure may take the form of an entirely hardware embodiment, an entirely software embodiment (including firmware, resident software, micro-code, etc.), or an embodiment combining software and hardware aspects, all possibilities of which can be referred to herein as a “circuit,” “module,” or “system.” A “circuit,” “module,” or “system” can include one or more portions of one or more separate physical hardware and/or software components that can together perform the disclosed function of the “circuit,” “module,” or “system”, or a “circuit,” “module,” or “system” can be a single self-contained unit (e.g., of hardware and/or software). Furthermore, aspects of this disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of this disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of this disclosure may be described above with reference to illustrations and/or block diagrams of methods, apparatus (systems) and computer program products according to embodiments of this disclosure. It will be understood that each block of any flowchart illustrations and/or block diagrams, and combinations of blocks in any flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in any flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified herein.

Those having ordinary skill in the art understand that any numerical values disclosed herein can be exact values or can be values within a range. Further, any terms of approximation (e.g., “about”, “approximately”, “around”) used in this disclosure can mean the stated value within a range. For example, in certain embodiments, the range can be within (plus or minus) 20%, or within 10%, or within 5%, or within 2%, or within any other suitable percentage or number as appreciated by those having ordinary skill in the art (e.g., for known tolerance limits or error ranges).

The articles “a”, “an”, and “the” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

Any suitable combination(s) of any disclosed embodiments and/or any suitable portion(s) thereof are contemplated herein as appreciated by those having ordinary skill in the art in view of this disclosure.

The embodiments of the present disclosure, as described above and shown in the drawings, provide for improvement in the art to which they pertain. The technology described herein may be applicable to all manufacturing environments. While the subject disclosure includes reference to certain embodiments, those skilled in the art will readily appreciate that changes and/or modifications may be made thereto without departing from the spirit and scope of the subject disclosure.

What is claimed is:

1. A product identification and tracking interface system, the interface system comprising:
an interface unit including:
an input/output configured and adapted to be coupled to at least one of a tracking system or an identification system;
a memory configured to store instructions; and
a processor disposed in communication with said memory, wherein said processor upon execution of the instructions is configured to:
receive a trigger command from a tracking system;
send a read command to an identification system;
receive a respective identifier from the identification system;
package the respective identifier into a packaged identifier in a format readable by the tracking system; and
send the packaged identifier to the tracking system.

2. The interface system as recited in claim 1, wherein the read command prompts the identification system to capture a product image.

3. The interface system as recited in claim 2, wherein the respective identifier is based on the product image.

4. The interface system as recited in claim 1, wherein the respective identifier is an alpha-numeric identifier in the form of a meta-data message packet.

5. The interface system as recited in claim 1, wherein the respective identifier is a stored identifier within the identification system.

6. A product identification and tracking system, the system comprising:
an identification system;
a tracking system;
an interface unit coupled between the identification system and the tracking system, the interface unit including:
an input/output configured and adapted to be coupled to at least one of the tracking system or the identification system;
a memory configured to store instructions; and
a processor disposed in communication with said memory, wherein said processor upon execution of the instructions is configured to:
receive a trigger command from a tracking system;
send a read command to an identification system;
receive a respective identifier from the identification system;
package the respective identifier into a packaged identifier in a format readable by the tracking system; and
send the packaged identifier to the tracking system.

7. The system as recited in claim 6, wherein the identification system is a distributed identification system, having at least a portion of the identification system stored in the interface unit.

8. The system as recited in claim 6, wherein the read command prompts the identification system to capture a product image.

9. The system as recited in claim 8, wherein the respective identifier is based on the product image.

10. The system as recited in claim 6, wherein the respective identifier is an alpha-numeric identifier in the form of a meta-data message packet.

11. The system as recited in claim 6, wherein the respective identifier is a stored identifier within the identification system.

12. A method for interfacing between an identification system and tracking system, the method comprising:
receiving a trigger command in an interface system from a tracking system;
sending a read command to at least one identification system;
receiving a respective identifier in the interface system from the identification system; and
packaging the respective identifier into a packaged identifier in a format readable by the tracking system; and
sending the packaged identifier to the tracking system.

13. The method as recited in claim 12, capturing an image of a product with the identification system.

14. The method as recited in claim 13, retrieving the respective identifier from a storage with the identification system based on the image.
